(19) United States
(12) Patent Application Publication
(10) Pub. No.: US 2015/0293773 A1
(43) Pub. Date: Oct. 15, 2015

(54) VIRTUAL MACHINES

(71) Applicant: HANGZHOU H3C TECHNOLOGIES CO., LTD., Hangzhou, Zhejiang (CN)

(72) Inventors: Zhifeng Cai, Beijing (CN); Zhonghua Guo, Beijing (CN)

(21) Appl. No.: 14/440,838

(22) PCT Filed: Oct. 28, 2013
(86) PCT No.: PCT/CN2013/086046

§ 371 Date: May 5, 2015

(30) Foreign Application Priority Data
Nov. 14, 2012 (CN) 201210458838.6

(51) Int. Cl. G06F 9/455; H04L 29/08; H04L 29/06

(52) U.S. Cl. CPC G06F 9/45558; H04L 67/42; H04L 67/141; H04L 67/28; G06F 2009/45595

(57) ABSTRACT

A method for use in a computer network comprises a proxy separately establishing a connection with a virtual machine VM running on a first server and establishing a connection with a client to enable the client to access the VM on the first server. Upon the proxy detecting a disconnection with the VM on the first server, it obtains information of a current position of the VM from a management platform, and, once the proxy obtains the information, if the information indicates that the VM is running on a second server, the proxy establishes a connection with the second server based on the obtained information so as to enable the client to access the VM on the second server.

### BACKGROUND

One or more Virtual Machines (VM) can be simulated on a physical computer. Each VM functions in a similar way to a physical computer and a client may remotely access a VM over a computer network. Virtual Network Computing (VNC) is an example of a software tool for remotely controlling multiple VMs. While running on a first physical host (first server), a VM may be moved, or migrated, to a second physical host (second server), whereby the VM operates as usual on the second physical host as when running on the first physical host. Such a process is referred to as VM migration, which may be performed when the first physical host requires maintenance, an update of software or hardware, for load sharing and balancing in the system, to handle a fault that has been detected in a physical host, or to manage the power consumption of the system and so on.

### BRIEF DESCRIPTION OF THE DRAWINGS

The present disclosure will be described, by way of examples, with reference to the drawings, in which:

FIG. 1 is a flow diagram of an example of a method used in a computer network during VM migration;

FIG. 2 is a flow diagram of another example of a method used in a computer network during VM migration;

FIG. 3 is a schematic diagram of an example configuration of a computer network; and

FIG. 4 is a schematic diagram of an example apparatus for use in the computer network of FIG. 3.

### DETAILED DESCRIPTION

In a computer network, a proxy server, or proxy, is a server, which may be a computer or an application hosted by a computer, that acts as an intermediary for requests from clients seeking resources from other servers in the network. For example, in a computer network such as a VNC network, a proxy may be provided to forward data between a client and a server, and to perform a shielding function between the client and the server by preventing the client from directly contacting the server, thus improving the security of the system. Since all messages are sent and received via the proxy, the messages can be audited at the proxy and security measures such as a key, a password or an encryption can be added to the messages to further improve the security of the system.

After a VM, to which a client is connected via a virtual desktop, has been migrated from a first server to a second server, the connection of the proxy to the VM is broken. At this point, the proxy loses the information of the current position of the VM. The information may, for example, include the server on which the VM is currently running and the port number of the server for connecting with the VM. In this case, the connection of the client to the first server is eventually terminated when it times-out as no data is exchanged, and the client is required to establish a new connection to the VM on the second server, using a VNC viewer, before it is able to access the VM again via a virtual desktop.

An example of a method for use in a computer network during VM migration comprises a proxy establishing a connection with a virtual machine VM running on a first server and establishing a connection with a client to enable the client to access the VM on the first server. Upon the proxy detecting a disconnection with the VM on the first server, it obtains information of a current position of the VM from a management platform, and, once the proxy obtains the information, if the information indicates that the VM is running on a second server, the proxy establishes a connection with the second server based on the obtained information so as to enable the client to access the VM on the second server.

According to the example, upon the proxy detecting that the connection with the VM on the first server is broken, it obtains the information of the current position of the VM from the management platform and, using the obtained information, the proxy may quickly re-establish a connection with the VM to enable the client to continue to remotely access the VM with little or no interruption. It is therefore possible to minimize interruption when providing the client with access to a VM.

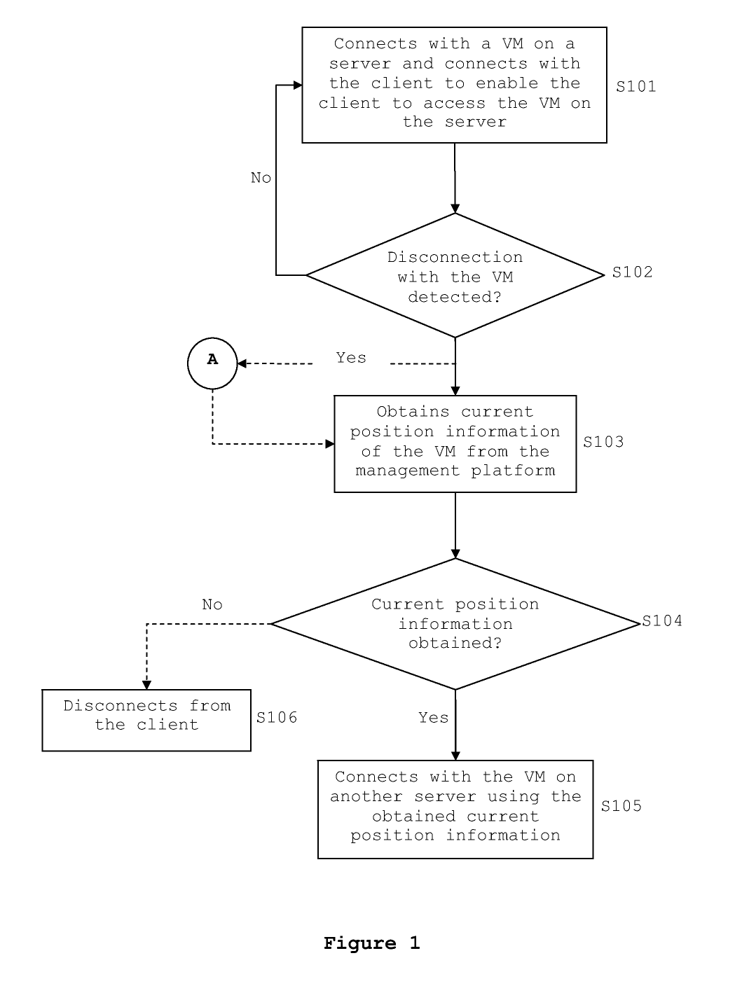

In the following example, a method is described with reference to FIG. 1 for use in a computer network based on VNC. In the example, the computer network comprises a client, a first server, a second server, a proxy and a management platform. One or more VMs may be running on each of the first and second servers, and the client may access a VM on one of the first and second servers through the proxy under the management of the management platform.

At block S101, the proxy establishes a connection with a VM on the first server and establishes a connection with the client, thereby enabling the client to access the VM on the first server.

The proxy communicates with the management platform to provide connections between clients and servers. When the proxy receives information from the management platform such as an IP address, a port number and a password of a server at which a VM is located, and when it determines that a client requires remote access to the VM, the proxy initiates a connection with the server to establish a connection with the VM on the server using the port information of the VM on the server and the IP address of the server notified by the management platform. The proxy then listens for information on port, connection password and other information for returning to the management platform. The management platform enables the client to establish a connection with the proxy by using the port and connection password obtained during the listening. If the verification is successful, a connection between the proxy and the client is established. The creation and connection of a virtual desktop is thus complete, and the client is now able to remotely access the VM. The desktop of the VM is displayed on the client side, and the user may use the VM conveniently in the same way as using a display terminal to display the desktop running on a local physical host.

At block 102, the proxy determines whether a disconnection with the VM on the first server is detected. For example, the proxy may set a timer when data is received from the VM on the first server, and if no data is received again before the timer expires, the proxy determines that there is a disconnection with the VM on the first server. Upon detecting that a disconnection with the VM on the first server, at block S103, the proxy obtains information of the current position of the VM from the management platform. When the proxy is disconnected from the VM on the first server, it does not necessarily lead to a disconnection of the proxy with the first server. For example, the proxy may remain connected with the first server to mediate between other clients and other VMs running on the first server. It may also be possible that the disconnection between the proxy and the VM on the first server is caused by a disconnection between the proxy and the first server, for example when the first server is down.

At block S104, if the proxy successfully obtains the current position information of the VM from the management platform, it establishes a connection with the VM using the obtained current position information at block S105, to enable the client to continue accessing the VM, which now runs on the second server. Otherwise, if the proxy cannot obtain the current position information from the management platform, at block S106, it disconnects from the client.

When the VM migrates from the first server to the second server, or when the VM is shut down, the proxy detects a disconnection from the VM on the first server. When the VM migrates, the management platform learns the current position (second server) of the VM, and the proxy may obtain the current position information of the VM from the management platform. On the other hand, when the VM is shut down, the management platform learns that said VM is shut down (the current state of the VM is a shutdown state), the current position information of the VM therefore does not change, and the proxy cannot obtain the current position information of the VM from the management platform. In this case, the proxy disconnects from the client. According to the example, when the VM migrates, the client is able to access the VM on the server side with little or no interruption. When the VM is shut down, the proxy disconnects from the client, thus the client is informed of the operating state of the VM promptly.

In an example, when the proxy detects the disconnection from the VM on the first server at block S102, if data sent from the client to the VM is received in the meantime, the proxy may cache the received data. When the proxy establishes a connection with the VM again on the second server at block S105 using the obtained position information, if it is determined that the data sent from the client to the VM is cached locally, the proxy may send the cached data to the VM sequentially.

In this way, data sent by the client is not lost during the migration of the VM from the first server to the second server.

In another example, an upper limit may be set for the amount of cache data stored at the proxy. When the data cache reaches the upper limit, subsequently received data may be discarded, thus providing control of the storage capability of the proxy and preventing an overloading of data at the proxy. Once a connection with the VM is established using the obtained position information, the proxy may again send the cached data to the VM, thus improving the user's experience of an uninterrupted remote access to the VM.

In further examples, when the proxy detects the disconnection from the VM, whether due to a migration or shutdown of the VM, the proxy may attempt to obtain information of the current position of the VM in a passive method or an active method.

In a passive method, when the proxy detects the disconnection from the VM on the first server, the proxy may obtain the current position information of the VM by waiting and receiving a message sent from the management platform. The received message contains the current position information of the VM obtained by the management platform, and is received by the proxy within a first predetermined time period. Using the obtained current position information, the proxy may then establish a connection with the VM again on the second server to enable the client to continue accessing the VM remotely.

In this example, if the proxy receives a message from the management platform within the first predetermined time period and the message indicates that the VM has shut down, the proxy may then disconnect from the client. If the proxy does not receive a message from the management platform within the first predetermined time period, the proxy may assume that there is an error and disconnect from the client.

In the example of the passive method, when the proxy detects the disconnection from the VM on the first server, it waits for the management platform to send the current position information (or state information, i.e., the VM is in a shutdown state) of the VM. When the proxy receives the message sent by the management platform within the first predetermined time period, it responds accordingly based on information contained in the received message. If no message is received within the first predetermined time period, the proxy disconnects from the client and performs error processing. For example, the proxy may record an error log. In an example, HTTP service may be launched on the proxy to provide a ReSTful (Representational State Transfer) interface to the management platform, and the management platform sends the current position information of the VM to the proxy using an HTTP message.

In an active method, upon detecting the disconnection from the VM on the first server, the proxy sends a request to the management platform to request the current position information of the VM.

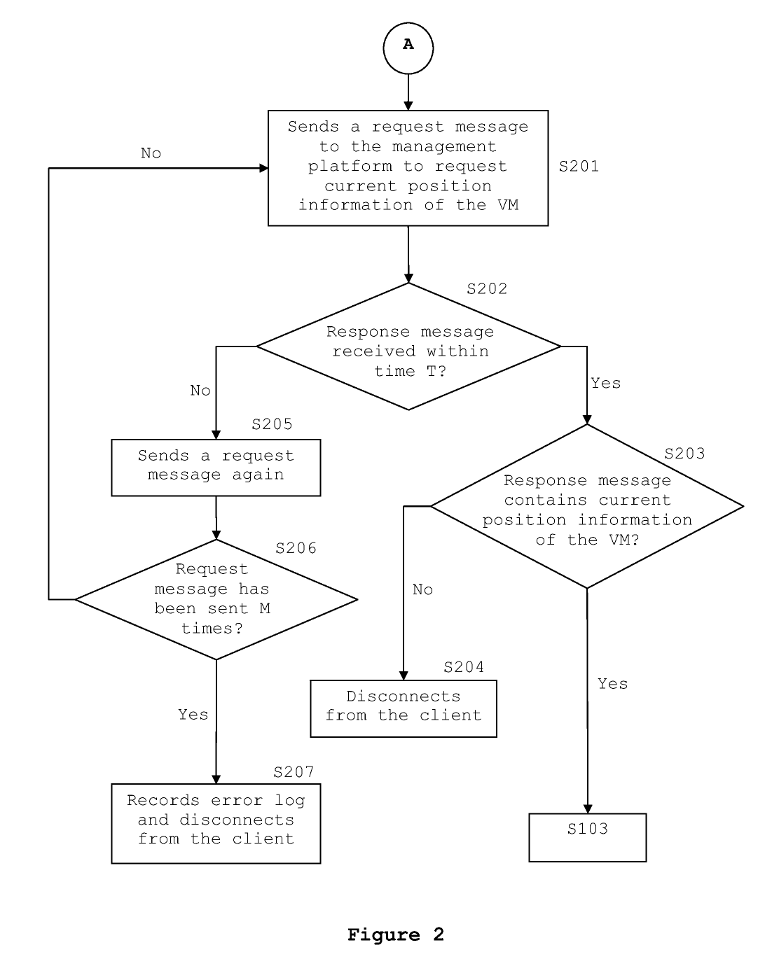

An example of the active method is illustrated in the flow diagram of FIG. 2. At block S201, the proxy sends a request message to the management platform to request the current position information of the VM.

At block S202, the proxy determines whether a response message is received from the management platform within a second predetermined time period T.

If so, at block S203, the proxy determines if the received response message contains the current position information of the VM.

If it is determined that the response message contains the current position information of the VM, the process proceeds from block S103 as described above with reference to FIG. 1. Thus, the proxy obtains the current position information of the VM, and establishes a connection with the VM on the second server using the obtained current position information to enable the client to continue accessing the VM remotely.

If it is determined that the response message does not contain the current position information of the VM, for instance the response message indicates that the VM has been shut down, at block S204, the proxy disconnects from the client.

Referring back to block S202, if the proxy does not receive a response message from the management platform within the second predetermined time period T, at block S205, the proxy determines if the request message has been sent to the management platform for a predetermined number (M) of time. If the predetermined number of requests has not been reached, the process returns to block S201 and the proxy sends a request message to the management platform again.

If the predetermined number of requests has been reached, at block S206, the proxy determines that there is an error and records an error log, then disconnects from the client. In an example, a virtual machine position information querying service may be launched on the management platform, providing a ReSTful interface to the proxy.

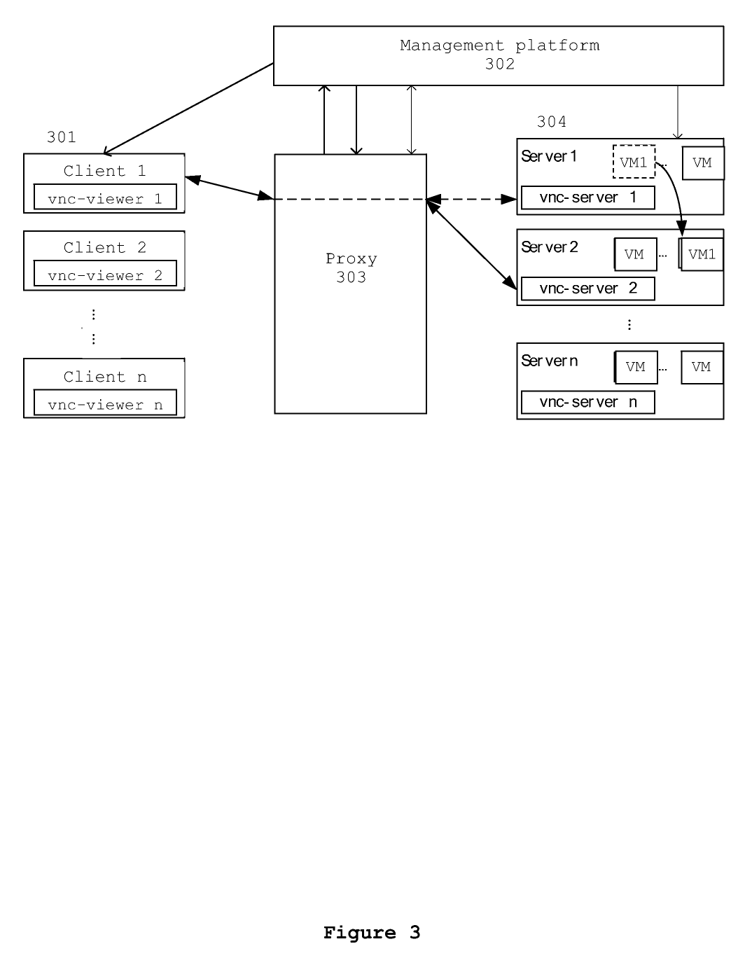

An example of a configuration of a computer network based on VNC is illustrated in FIG. 3. The computer network comprises a plurality of clients 301 (Client 1, Client 2, . . . , Client n), a management platform 302, a proxy 303 and a plurality of servers 304 (Server 1, Server 2, . . . , Server n).

In the example, Client 1 requests remote access of VM 1 running on Server 1. Client 1 logs on to the management platform using a browser such as IE (Internet Explorer) via the proxy in order to execute a command for logging on to a remote desktop. The management platform communicates with the proxy, and notifies the proxy of information such as the IP address of Server 1 on which VM 1 locates, and the port and password of Server 1. When creating the VM, the port at which the VM is created on Server 1 may be specified using a suitable hardware virtualization technology, for example QEMU (Quick EMUlator) or qemu-kvm.

The proxy uses a password to establish a connection to the desktop of the VM at the specified port of Server 1 using the specified IP address.

The proxy initiates listening on the Server 1 side, and returns the port listen_port and the connection password obtained during the listening to the management platform.

The management platform starts vnc-viewer 1 on Client 1. For example, by launching the vnc-viewer 1 on the browser of Client 1 using a suitable application deployment technology such as Java Web Start.

Through using vnc-viewer 1, Client 1 establishes a connection to the proxy according to the specified listen_port, verified by the obtained connection, and completes the connection with the virtual desktop between Client 1 and VM1 via the proxy. The desktop of VM1 is displayed on the client side, and the user may use VM 1 in the same manner as a desktop of a local physical host displayed on the display terminal of the local physical host.

The management platform may migrate VM 1 from Server 1 to Server 2, for example due to requirements of load balance or other service requirements.

After the migration, the proxy detects a disconnection from VM 1, and sends a request message to the management platform to request the current position information of VM1, including the IP address of Server 2 and the port number of vnc-server 2, for example.

Upon receiving a response message containing the current position information of VM 1 sent by the management platform, the proxy obtains the current position information of VM 1, i.e., the IP address of Server 2 and the port number of vnc-server 2. The proxy uses the IP address of Server 2 and the port number of vnc-server 2 to establish a connection with the migrated VM 1 on vnc-server 2. According to the example, it is possible to provide a client with a VNC virtual desktop with little or no interruption during VM migration, thus improving the experience of the client using the virtual desktop.

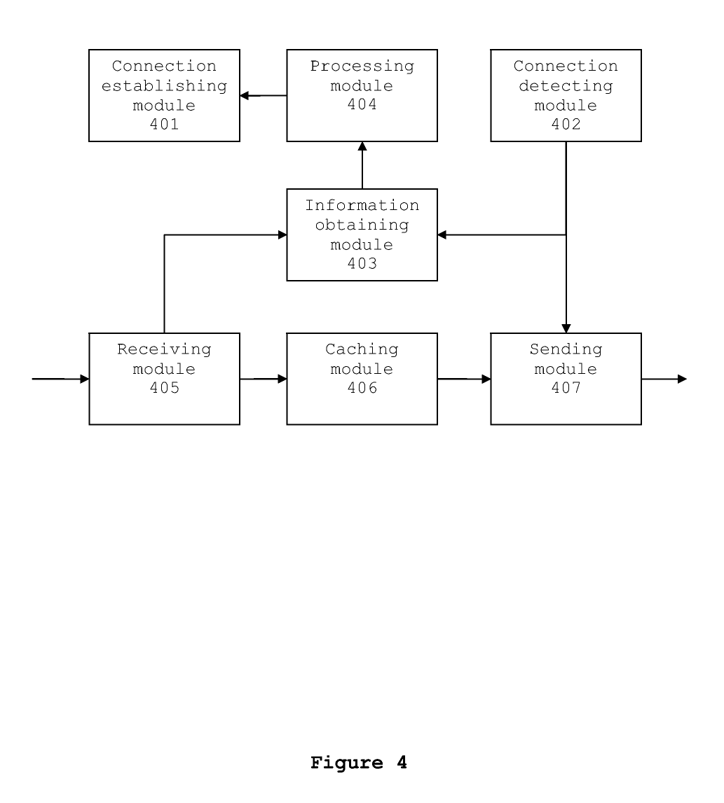

An example of an apparatus for use in or with a proxy in a method described in the examples above is shown in FIG. 4. The apparatus comprises a connection establishing module 401, a connection detecting module 402, an information obtaining module 403, and a processing module 404.

The connection establishing module 401 is configured to establish a connection with a virtual machine VM running on a server of the computer network and to establish a connection with a client to enable the client to access the VM on the server.

The connection detecting module 402 is configured to detect if the connection with the VM on the server is disconnected.

The information obtaining module 403 is configured to obtain information of a current position of the VM from a management platform of the computer network when the connection detecting module detects a disconnection with the VM.

The processing module 404 is configured to instruct the connection establishing module to establish a connection with another server of the computer network based on the information obtained by the information obtaining module 403 so as to enable the client to access the VM on the another server, if the obtained information indicates that the VM is running on the another server.

In an example, when the information obtaining module 403 is unable to obtain the information of a current position of the VM, the processing module 404 is configured to determine that the VM is shut down, and to disconnect the connection with the client.

In further examples, the apparatus may comprise a receiving module 405, a caching module 406 and a sending module 407.

In an example, the receiving module 405 may be configured to receive data from the client to be sent to the VM on the server. The caching module 406 is configured to cache the received data upon the connection detecting module detecting a disconnection with the VM on the server. The sending module 407 is configured to send the cached data to the VM on the another server upon the connection establishing module establishing the connection with the another server.

In another example, the receiving module 405 may be further configured to receive a message sent by the management platform. The information obtaining module 403 may then be further configured to obtain the information of a current position of the VM from the received message, if the receiving module receives the message within a first predetermined time period containing the information of the current position of the VM obtained by the management platform.

In yet another example, the receiving module 405 may be further configured to receive a message sent by the management platform. The processing module 404 may then be further configured to determine that the VM is shut down if the receiving module receives the message within a first predetermined time period, the message indicating that the VM has been shut down, or if the receiving module does not receive a message from the management platform within the first predetermined time period.

In a further example, the sending module 407 may be further configured to send a request message to the management platform requesting the information of a current position of the VM when the connection detecting module detects the disconnection with the VM on the server. The receiving module 405 may then be further configured to receive a response message sent by the management platform. The information obtaining module 403 may be further configured to obtain the information of the current position of the VM from the received response message. The processing module 404 may be further configured to, if the receiving module receives the response message within a second predetermined time period, instruct the connection establishing module to establish a connection based on the response message when the response message contains the information of the current position of the VM, or to disconnect the connection with the client when the response message indicates that the VM has been shut down.

In this example, the sending module 407 may be configured to send again the request message to the management platform if the receiving module does not receive a response message from the management platform within the second predetermine time period. The processing module 404 may be configured to record an error log and to disconnect the connection with the client if the receiving module 405 does not receive a response message from the management platform after the sending module has sent the request message to the management platform a predetermined number of times.

The functional modules in the examples above may be either integrated as a single piece or disposed as individual separate pieces combined into one unit, or divided into a plurality of sub-units.

According to the examples above, when the proxy detects a disconnection from the VM, it obtains the current position information of the VM from the management platform, uses the obtained current position information to establish a new connection with the VM on a different server, thus enabling the client to access the VM remotely via a virtual desktop with little or no interruption to the access.

The proxy may detect a disconnection from the VM due to either the VM being shutdown and or migrated to a different server. When the VM is migrated, the proxy learns the current position information of the VM after the migration, and establishes a connection with the VM according to the obtained current position information, thus allowing the client to access the VM with little or no interruptions. When the VM is shut down, no current position information is obtained, thus there will be no attempt by the proxy to reconnect with the VM, and the connection with the client will be disconnected. It is therefore possible for the client to determine the shutdown of the VM timely, and improving the user experience of the virtual desktop.

When disconnected from the VM on the server during migration, the proxy caches the data sent from the client to the server. After establishing a connection with the VM on the new server after the migration, the proxy sends the cached data to the VM. In this way of caching data temporarily while re-establishing a connection with the VM, interruption to the access to the virtual desktop by the client is further minimized.

Although the flow diagrams described above show a specific order of execution, the order of execution may differ from that which is depicted.

The above examples can be implemented by hardware, software, firmware, or a combination thereof. For example, the various methods and functional modules described herein may be implemented by a processor (the term processor is to be interpreted broadly to include a CPU, processing unit, ASIC, logic unit, or programmable gate array etc.). The methods and functional modules may all be performed by a single processor or divided amongst several processors. The methods and functional modules may be implemented as machine readable instructions executable by one or more processors, hardware logic circuitry of the one or more processors, or a combination thereof. Further, the teachings herein may be implemented in the form of a software product, the computer software product being stored in a storage medium and comprising a plurality of instructions for making a computer device (e.g. a personal computer, a server or a network device such as a router, switch, access point etc.) implement the method recited in the examples of the present disclosure.

It should be understood that embodiments of the method and device described above are implementation examples only, and do not limit the scope of the invention. Numerous other changes, substitutions, variations, alternations and modifications may be ascertained by those skilled in the art, and it is intended that the present disclosure encompass all such changes, substitutions, variations, alterations and modifications as falling within the spirit and scope of the appended claims.

1. A method for use in a computer network comprising a client, a first server, a second server, a proxy and a management platform, the method comprising:
the proxy establishing a connection with a virtual machine VM running on the first server and establishing a connection with the client to enable the client to access the VM on the first server; and
the proxy detecting a disconnection with the VM on the first server, obtaining information of a current position of the VM from the management platform, and, when the proxy obtains the information, if the information indicates that the VM is running on the second server, establishing a connection with the second server based on the obtained information so as to enable the client to access the VM on the second server.

2. The method of claim 1 further comprising:
when the proxy is unable to obtain the information of a current position of the VM, determining that the VM is shut down, and disconnecting the connection with the client.

3. The method of claim 1 further comprising:
upon detecting a disconnection with the VM on the first server, the proxy caching data received from the client to be sent to the VM on the first server; and
upon establishing the connection with the second server, the proxy sending the cached data to the VM on the second server.

4. The method of claim 1 wherein the proxy obtains the information of a current position of the VM by receiving a message sent by the management platform within a first predetermined time period, the message containing the information of the current position of the VM obtained by the management platform.

5. The method of claim 2 wherein the proxy determines that the VM is shut down by receiving a message sent by the management platform within a first predetermined time period, the message indicating that the VM has been shut down, or if the proxy does not receive a message from the management platform within the first predetermined time period.

6. The method of claim 1 further comprising:
upon detecting the disconnection with the VM on the first server, the proxy sending a request message to the management platform requesting the information of a current position of the VM; and
upon receiving a response message sent by the management platform within a second predetermined time period, the proxy establishing a connection based on the response message if the response message contains the information of the current position of the VM, or disconnecting the connection with the client if the response message indicates that the VM has been shut down.

7. The method of claim 6 further comprising:
the proxy sending again the request message to the management platform if no response message is received from the management platform within the second predetermine time period; and
the proxy recording an error log and disconnecting the connection with the client if no response message is received from the management platform after the proxy has sent the request message to the management platform a predetermined number of times.

8. A method for use in a computer network comprising a client, a first server, a second server, a proxy and a management platform, the method comprising:
the proxy establishing a connection with a virtual machine VM running on the first server and establishing a connection with the client to enable the client to access the VM on the first server; and
the proxy detecting a disconnection with the VM on the first server, obtaining information of a current position of the VM from the management platform, and, when the proxy obtains the information, if the information indicates that the VM is running on the second server, establishing a connection with the second server based on the obtained information so as to enable the client to access the VM on the second server;
when the proxy is unable to obtain the information of a current position of the VM, determining that the VM is shut down, and disconnecting the connection with the client.

9. An apparatus for use in a computer network, the computer network comprising a client, a first server, a second server and a management platform, the apparatus comprising:
a connection establishing module to establish a connection with a virtual machine VM running on a server of the computer network and to establish a connection with a client to enable the client to access the VM on the server;
a connection detecting module to detect if the connection with the VM on the server is disconnected;
an information obtaining module to obtain information of a current position of the VM from a management platform of the computer network when the connection detecting module detects a disconnection with the VM; and
a processing module to instruct the connection establishing module to establish a connection with another server of the computer network based on the information obtained by the information obtaining module so as to enable the client to access the VM on the another server, if the obtained information indicates that the VM is running on the another server.

10. The apparatus of claim 9 wherein:
when the information obtaining module is unable to obtain the information of a current position of the VM, the processing module is to determine that the VM is shut down, and to disconnect the connection with the client.

11. The apparatus of claim 9 further comprising:
a receiving module to receive data from the client to be sent to the VM on the server;
a caching module to cache the received data upon the connection detecting module detecting a disconnection with the VM on the server; and
a sending module to send the cached data to the VM on the another server upon the connection establishing module establishing the connection with the another server.

12. The apparatus of claim 9 wherein
the receiving module is further to receive a message sent by the management platform; and
the information obtaining module is to obtain the information of a current position of the VM from the received message, if the receiving module receives the message within a first predetermined time period containing the information of the current position of the VM obtained by the management platform.

13. The method of claim 10 wherein
the receiving module is further to receive a message sent by the management platform; and
the processing module is to determine that the VM is shut down if the receiving module receives the message within a first predetermined time period, the message indicating that the VM has been shut down, or if the receiving module does not receive a message from the management platform within the first predetermined time period.

14. The apparatus of claim 9 wherein
the sending module is further to send a request message to the management platform requesting the information of a current position of the VM when the connection detecting module detects the disconnection with the VM on the server;
the receiving module is further to receive a response message sent by the management platform;
the information obtaining module is further to obtain the information of the current position of the VM from the received response message;
the processing module is further to, if the receiving module receives the response message within a second predetermined time period, instruct the connection establishing module to establish a connection based on the response message when the response message contains the information of the current position of the VM, or to disconnect the connection with the client when the response message indicates that the VM has been shut down.

15. The apparatus of claim 14 wherein
the sending module is further to send again the request message to the management platform if the receiving module does not receive a response message from the management platform within the second predetermine time period; and
the processing module is further to record an error log and to disconnect the connection with the client if the receiving module does not receive a response message from the management platform after the sending module has sent the request message to the management platform a predetermined number of times.
